(19) United States
(12) Patent Application Publication
(10) Pub. No.: US 2007/0274701 A1
(43) Pub. Date: Nov. 29, 2007

(54) TRANSPARENT DISPLAY AND CAMERA

(75) Inventors: Toru Chiba, Tokyo (JP); Takanobu Shiokawa, Kanagawa (JP); Takaomi Sekiya, Tokyo (JP); Yukio Kubota, Saitama (JP); Hiroki Yamazaki, Saitama (JP); Yoshiko Okabe, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/753,832

(22) Filed: May 25, 2007

(30) Foreign Application Priority Data
May 29, 2006 (JP) 2006-148021

(51) Int. Cl. G03B 13/10

(52) U.S. Cl. 396/232

(57) ABSTRACT

A transparent display comprising first and second transparent substrates first and second transparent electrodes, a polymer dispersed liquid crystal layer, and first and second light sources, is provided. The first and second transparent electrodes are mounted on the inside surfaces of the first and second transparent substrates. The inside surfaces of the first and second transparent substrates face each other. The polymer dispersed liquid crystal layer fills the gap between the first and second transparent electrodes. The polymer dispersed liquid crystal layer comprises a polymer material and a liquid crystal. The first and second light sources emit first and second light in predetermined directions, respectively. The predetermined directions are decided so that the first and second light are reflected at an outside surface.

### BACKGROUND OF THE INVENTION

1. Field of the Invention

The present invention relates to a transparent display where a required image is superimposed on an optical image of an object projected from the backside.

2. Description of the Related Art

In a single lens reflex camera, the optical image of an object which is incident on the object lens is projected onto a viewfinder. A transparent display which can be mounted on the viewfinder is known. On the transparent display, required information, such the an auto focus area, photometry area, and photographing conditions, can be displayed with an optical image projected from the backside.

A liquid crystal display, for mounting on a viewfinder is known as a transparent display. The liquid crystal display in the prior art comprises a glass substrate, a transparent electrode, and a liquid crystal layer. The required information can be superimposed on the optical image of an object by ordering the liquid crystal layer to shield the optical image from passing through the transparent display at a partial area of the entire display, and ordering the liquid crystal layer to let the optical image through at other areas of the entire display.

However, the only color in which the required information can be displayed, on the above transparent display in the prior art, is black.

### SUMMARY OF THE INVENTION

Therefore, an object of the present invention is to provide a transparent display that can display a required image in color.

According to the present invention, a transparent display comprising first and second transparent substrates, first and second transparent electrodes, a polymer dispersed liquid crystal layer, and first and second light sources is provided. The first and second transparent substrates face each other. The first and second transparent electrodes are mounted on the inside surfaces of the first and second transparent substrates. The inside surfaces of the first and second transparent substrates face each other. The polymer dispersed liquid crystal layer fills the gap between the first and second transparent electrodes. The polymer dispersed liquid crystal layer comprises a polymer material and a liquid crystal. The liquid crystal is dispersed in the polymer material. The first and second light sources emit first and second light in predetermined directions, respectively. The colors of the first and second light are first and second colors, respectively. The first and second lights are made incident on an edge surface of at least either said first or second transparent substrate. The predetermined directions are decided so that the first and second light emitted from the first and second light sources, respectively, and made incident on the edge surface is reflected at an outside surface. The outside surface is the opposite of the inside surface.

Further, the first and second light sources are arranged on the same side of the first or second transparent substrates.

Further, a reflection material is mounted on the opposite side of the first or second transparent substrates to where the first and second light sources are arranged.

Further, the predetermined direction is decided so that the reflection of the first and second light at the outside surface is total reflection.

Further, the liquid crystal is a p-type liquid crystal and the refractive index of the p-type liquid crystal against an ordinary ray is substantially the same as that of the polymer material. Or, the liquid crystal is an n-type liquid crystal and the refractive index of the n-type liquid crystal against an extraordinary ray is substantially the same as that of the polymer material.

According to the present invention, a transparent display comprising first and second transparent substrates, first and second transparent electrodes, a polymer dispersed liquid crystal, and first and second light sources is provided. The first and second transparent substrates face each other. The first and second transparent electrodes are mounted on the inside surfaces of the first and second transparent substrates. The inside surfaces of the first and second transparent substrates face each other. The polymer dispersed liquid crystal layer fills the gap between the first and second transparent electrodes. The polymer dispersed liquid crystal layer comprises a polymer material and a liquid crystal. The liquid crystal is dispersed in the polymer material. The first and second light sources emit first and second light, respectively. The colors of the first and second light are first and second colors in predetermined directions, respectively. The first and second light are made incident on an edge surface of the polymer dispersed liquid crystal. The predetermined directions are decided so that the first and second light emitted from the first and second light sources, respectively, and made incident on the inside surface from the side of the polymer dispersed liquid crystal are reflected at an outside surface. The outside surface is the opposite of said inside surface. Or the predetermined directions are decided so that the first and second light emitted from the first and second light sources, respectively, and progressing in the polymer dispersed liquid crystal, is parallel to the inside surface.

### BRIEF DESCRIPTION OF THE DRAWINGS

The objects and advantages of the present invention will be better understood from the following description, with reference to the accompanying drawings in which:

FIG. 1 is a cross-sectional view showing the internal structure of a single lens reflex camera having a transparent display as an embodiment of the present invention;

FIG. 2 is an external appearance of the transparent display;

FIG. 3 is a cross-sectional view showing the display unit and the light source unit in the thickness direction;

FIG. 4 is a perspective view showing the display unit from the front side;

FIG. 5 is a cross-sectional view showing the display unit and the light source unit in the thickness direction to explain the status of scattering light when voltage is not applied between the first and second transparent electrodes;

FIG. 6 is a cross-sectional view showing the display unit and the light source unit in the thickness direction to show the process of light progressing in the first glass substrate;

FIG. 7 is a cross-sectional view showing the display unit and the light source unit in the thickness direction to show the process of light progressing in the polymer dispersed liquid crystal layer;

FIG. 8 is a cross-sectional view showing the display unit and the light source unit in the thickness direction to show the process of light penetrating the second glass substrate when voltage is applied between the first and second transparent electrodes; and

FIG. 9 is an external appearance of the transparent display of another embodiment.

### DESCRIPTION OF THE PREFERRED EMBODIMENTS

The present invention is described below with reference to the embodiments shown in the drawings.

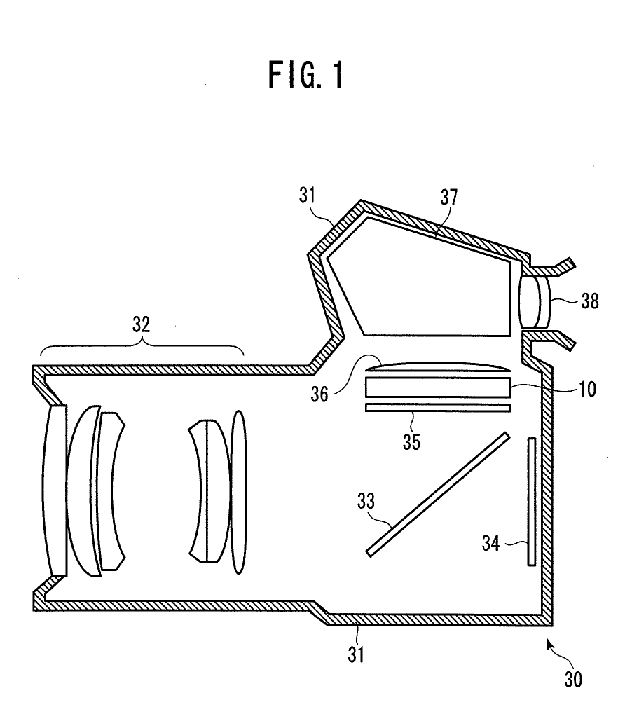

In FIG. 1, a single lens reflex camera 30 comprises a housing 31, a photographic optical system 32, a mirror 33, an imaging device 34, a focusing screen 35, a transparent display 10, a condenser lens 36, a pentaprism 37, and an eyepiece 38. In FIG. 1, the direction from left to right is defined as the direction from the front to the back of the single lens reflex camera 30. The direction from the top to the bottom is defined as the direction from the top to the bottom of the single lens reflex camera 30.

The photographic optical system comprises a plurality of lenses, such as a focusing lens and a zooming lens (not depicted). The mirror 33 is attached in the housing 31 so that the mirror 33 can rotate on a straight line axis perpendicular to the optical axis of the photographic optical system 32. Before and after the release operation, the mirror 33 is held in the path of the optical axis and the angle between the surface of the mirror 33 and the optical axis is kept at 45 degrees.

The focusing screen 35, the transparent display 10, the condenser lens 36, and the pentaprism 37 are mounted above the mirror 33. The imaging device 34 is mounted behind the mirror 33. In addition, the eyepiece is mounted behind the pentaprism 37.

Before and after the release operation, the optical image of an object passes through the photographic optical system 31 and is reflected by the mirror 33. The reflected optical image is focused on the focusing screen 35. The focused optical image passes through the focusing screen 35, the transparent display 10, the condenser lens 36, the pentaprism 37, and the eyepiece 38, where the optical image is observable to the user.

When a release button (not depicted) is depressed, the release operation commences. During the release operation, the mirror 33 is raised above the optical axis, a shutter (not depicted) opens, and the imaging device 34 captures the optical image.

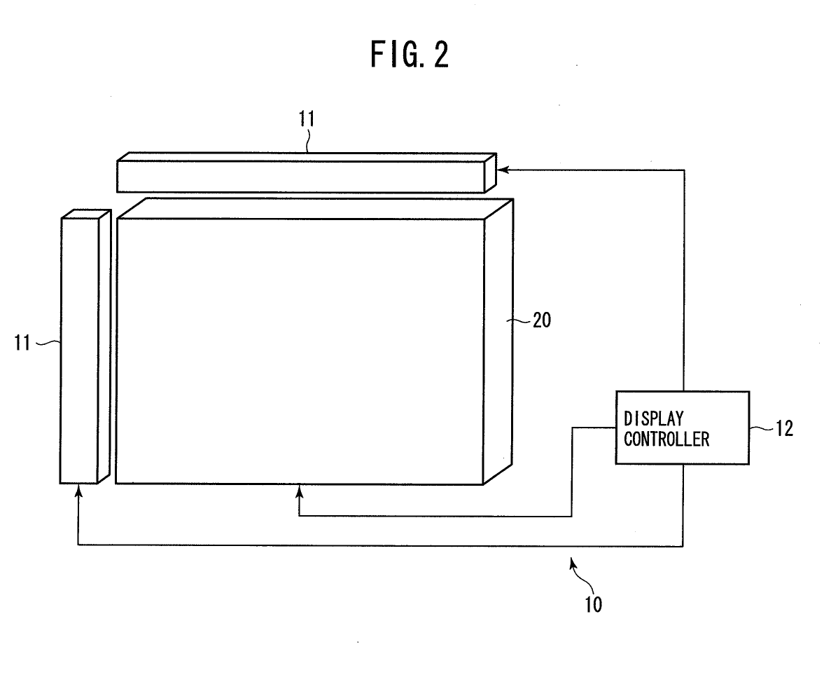

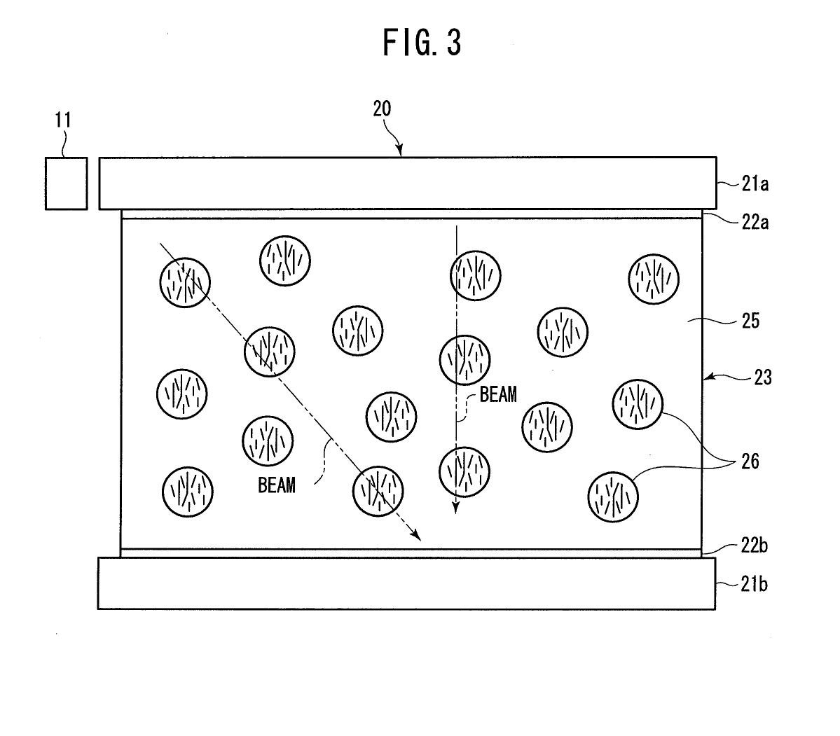

Next, the structure of the transparent display 10 is described below using FIGS. 2 and 3. As shown in FIG. 2, the transparent display 10 comprises a display unit 20, a light source unit 11, and a display controller 12.

The display unit 20 is formed as a rectangular plate. The optical image is projected onto one side of the plate and then transmitted through and to the other side of the plate. The light source unit 11 is mounted at the side of the display unit 20. The light source unit 11 emits red, green, and blue light, separately. The red, green, and blue light emitted from the light source unit 11 is incident on the side face of the display unit 20.

The display unit 20 and the light source unit 11 are connected electrically to the display controller 12. The display controller 12 controls the display unit 20 and the light source unit 11 so that the required information is superimposed on a projected optical image of an object on the display unit 20.

As shown in FIG. 3, the display unit 20 comprises first and second glass substrates 21a, 21b, first and second transparent electrode 22a, 22b, and a polymer dispersed liquid crystal layer 23. The first and second glass substrates 21a, 21b are shaped as rectangular plates and arranged to face each other.

The first and second transparent electrodes 22a, 22b are mounted between the first and second glass substrates 21a, 21b, and adhered on the inside surface of the first and second glass substrates 21a, 21b, respectively.

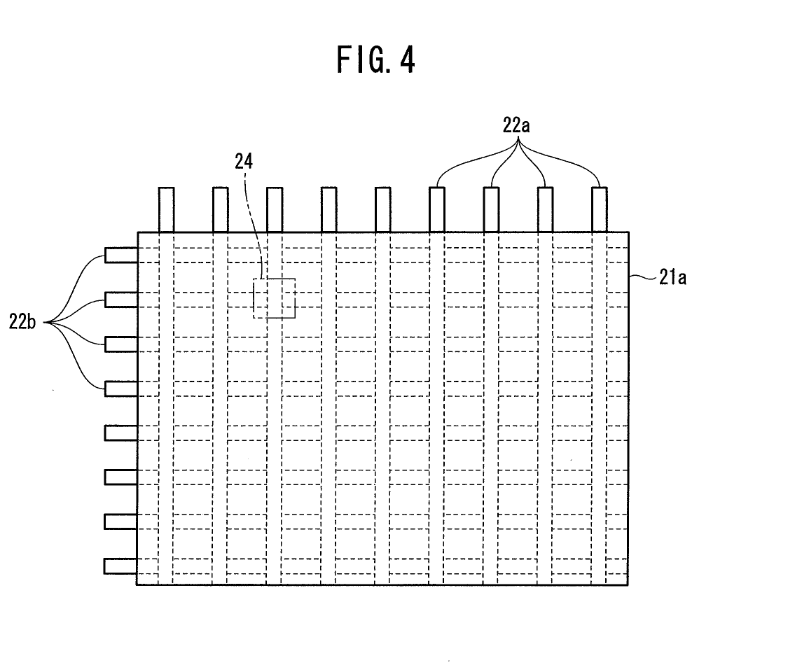

As shown in FIG. 4, a plurality of first transparent electrodes 22a are arranged so that each one is arranged lengthwise parallel to the shorter side of the first glass substrate 21a. A plurality of second transparent electrodes 22b are arranged so that each one is arranged lengthwise parallel to the longer side of the second glass substrate 21b.

A lot of unit cells 24 are constructed on the areas where the first and second transparent electrodes 22a, 22b overlap.

A polymer dispersed crystal liquid layer 23 is fills the gap between the first and second transparent electrodes 22a, 22b. The polymer dispersed crystal liquid layer 23 is made by dispersing innumerable liquid crystal droplets 26 in a polymer medium 25.

The refractive index of the first and second glass substrates 21a, 21b are the same as each other. A p-type liquid crystal is used for the liquid crystal droplets 26. The specification of the liquid crystal is such that the refractive indexes of a liquid crystal molecule in the p-type liquid crystal against an ordinary ray and an extraordinary ray, respectively, are greater than that of the first and second glass substrates 21a, 21b. In addition, a material with a specification such that the refractive index of the material is nearly equal against the extraordinary ray to that of the liquid crystal molecules in the p-type liquid crystal, is used for the polymer medium 25.

Incidentally, an n-type liquid crystal can be adaptable for the liquid crystal droplet 26. However, in such a case, the refractive index against the ordinary ray of the polymer medium 25 must be nearly equal to that of the liquid crystal molecules in the n-type liquid crystal.

When voltage is applied on the first and second transparent electrodes 22a, 22b, the liquid crystal molecules, which are long molecules, turn so that the liquid crystal molecules are parallel to a theoretical line connecting the first transparent electrode 22a to the second transparent electrode 22b (see FIG. 3). Consequently, the refractive indexes of the polymer medium 25 and the liquid crystal droplets 26 will be substantially the same. Accordingly, when a voltage is applied, a beam incident to the polymer dispersed liquid crystal layer 23 passes straight through, giving the polymer dispersed liquid crystal layer 23 a transparent quality.

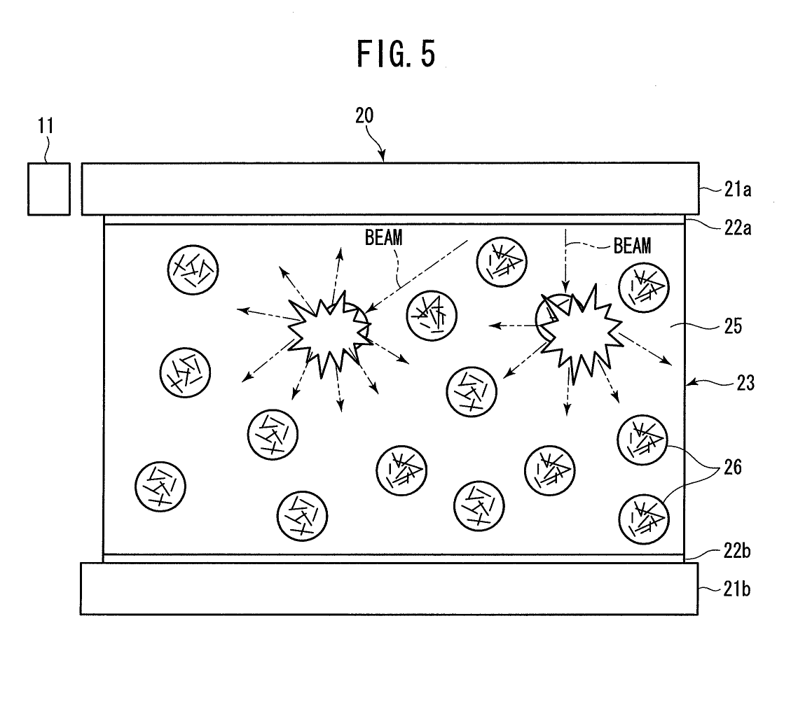

On the other hand, when a voltage is ceased to be applied between the first and second transparent electrodes 22a, 22b, the liquid crystal molecules turn to various orientations (see FIG. 5). In this case, a beam incident to the polymer dispersed liquid crystal layer 23 is dispersed by the liquid crystal droplets 26 and the polymer dispersed liquid crystal layer 23 is colored by the incident light.

Each light source unit 11 is mounted so that the two light source units 11 face onto two edge surfaces of the first glass substrate 21a (see FIG. 2). A reflection material (not depicted) which reflects incident light is mounted on the first glass substrate 21a so that the reflection material is arranged on the two opposing edge surfaces to the light source units 11. A beam passing through the first glass substrate 21a is reflected by the reflection material.

A light source unit 11 comprises red, green, and blue light sources (not depicted) that emit red, green, and blue light, respectively. The red, green, and blue light sources are organo-electroluminescence devices. The red, green, and blue light emitted from the red, green, and blue light sources have directivity. The red, green, and blue light sources are mounted so that the red, green, and blue light is emitted in predetermined directions toward the edge surface of the first glass substrate 21a, respectively.

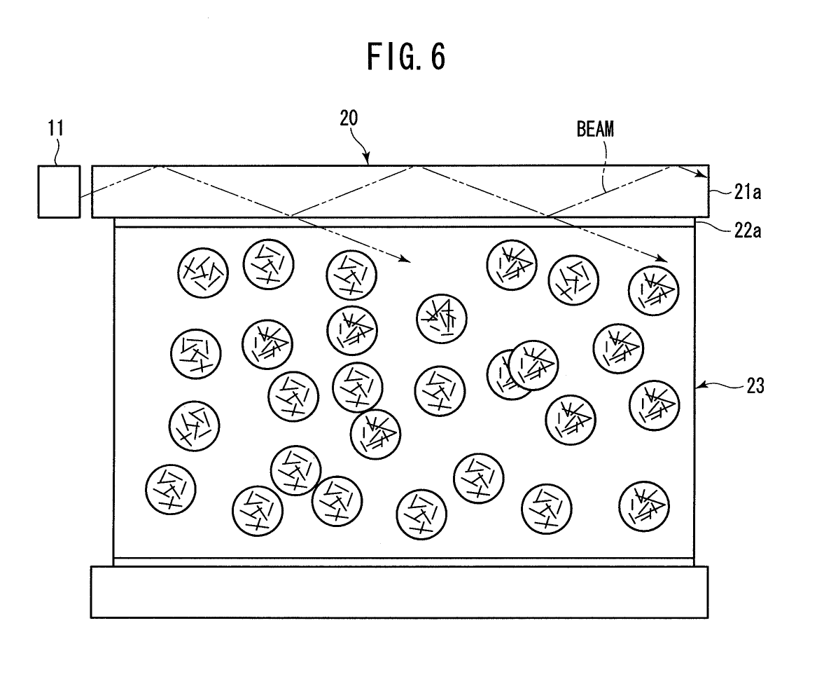

The predetermined directions are decided so that the light, which is emitted from each of the light sources, is made incident to the first glass substrate 21a and intersects the inside surface, which is facing the second glass substrate 21b, or an outside surface opposite to the inside surface. In addition, the predetermined direction is decided so that a beam incident to the first glass substrate 21a is reflected totally on the outside surface (see FIG. 6).

The transparent display 10 is mounted in the single lens reflex camera 30 so that the second glass substrate 21b faces the pentaprism 37. The light progressing through the first glass substrate 21a is not completely reflected, but partially passes through the outside surface even if the light is incident on the outside surface at an angle of incidence more than the critical angle. Consequently, it is preferable that the second glass substrate 21b faces the pentaprism 37 to prevent light from entering the pentaprism 37.

The operation of displaying a required image on the transparent display 10 is explained below.

The light emitted from the light source unit 11 is made incident on the first glass substrate 21a. As the incident light progresses through the inside of the first substrate 21a, the incident light is substantially and almost totally reflected on the outside surface of the first glass substrate 21a and partially reflected on the inside surface. A part of the incident light passes through the inside surface and enters the polymer dispersed crystal liquid layer 23 through the first transparent electrode 22a.

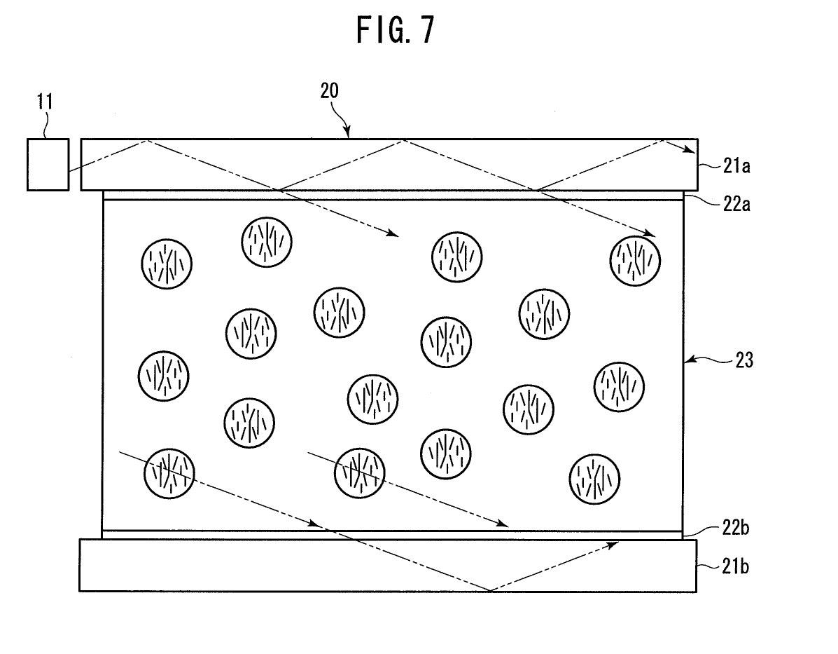

When a voltage is applied between the first and second transparent electrodes 22a, 22b, the refractive index of the entire polymer dispersed liquid crystal layer 23 is uniform. Consequently, an optical image incident to the transparent display 10 from a side of the first glass substrate 21a passes through the polymer dispersed crystal liquid layer 23 and is emitted from the second glass substrate 21b. In addition, a beam incident on the first glass substrate 21a goes straight and is made incident on the second glass substrate 21b (see FIG. 7).

The refractive indexes of the first and second glass substrates 21a, 21b are the same, so the angle of incidence from the first glass substrate to the polymer dispersed liquid crystal layer 23 through the first transparent electrode 22a is the same as the angle of incidence from the polymer dispersed liquid crystal layer 23 to the second glass substrate 21b through the second transparent electrode 22b. Consequently, the light incident on the second glass substrate 21b is reflected totally on the outside surface of the second glass substrate 21b. The totally reflected light from the outside surface of the second glass substrate 21b progresses through the inside of the second glass substrate 21b as the progressing light is reflected totally on the outside surface of the second glass substrate 21b and partially reflected on the inside surface, similar to the first glass substrate 21a.

Consequently, when a voltage is applied between the first and second transparent electrodes 22a, 22b, an optical image projected to the transparent display 10 is displayed on the transparent display 10.

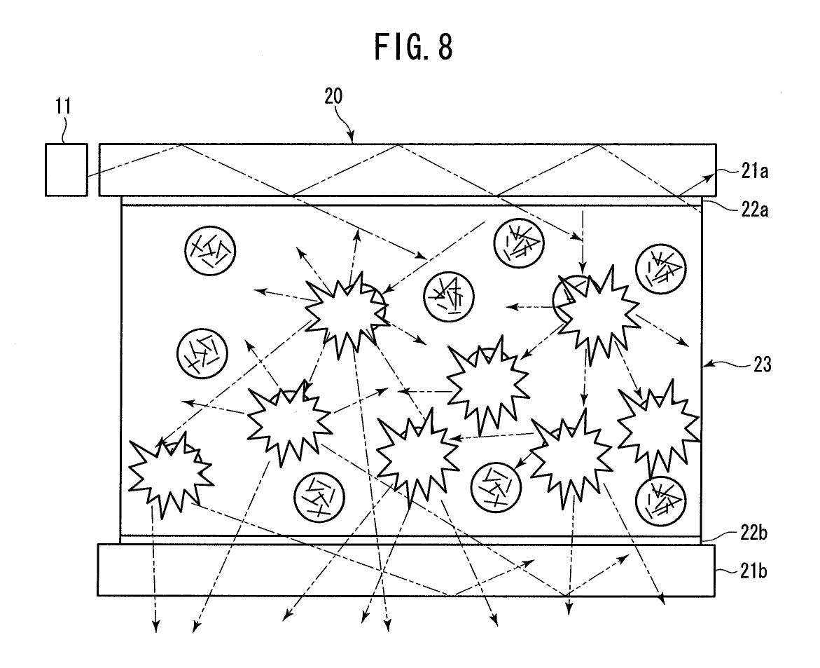

On the other hand, while no voltage is applied between the first and second transparent electrode 22a, 22b, the incident light is scattered by the polymer dispersed liquid crystal layer 23 (see FIG. 8). Consequently, an optical image incident to the transparent display 10 from the side of the first glass substrate 21a gets blurred on the second glass substrate 22b due to the scattering light in the transparent display 10.

The light incident on the polymer dispersed liquid crystal layer 23 from the light source unit 11 is scattered in numerous directions in the polymer dispersed liquid crystal layer 23. A part of the scattered light which progresses in the direction of the second glass substrate 21b becomes incident on the second glass substrate 21b. Light which is incident on the second glass substrate 21b by an angle of incidence more than the critical angle is reflected on the outside surface of the second glass substrate 21b. On the other hand, light which is incident on the second glass substrate 21b by an angle of incidence less than the critical angle passes through the second glass substrate 21b and is emitted therefrom. Consequently, while voltage is not applied between the first and second transparent electrodes 22a, 22b, the light emitted from the light source unit 11 is emitted from the second glass substrate 21b.

Incidentally, the magnitude of light which passes through the second glass substrate 21b can be controlled according to the voltage which is applied between the first and second transparent electrodes 22a, 22b.

When a required image is to be displayed on the transparent display 10, a plurality of the first transparent electrodes 22a are selected one by one. When one first transparent electrode 22a is selected, voltage data corresponding to the magnitudes of light which are required to be emitted at unit cells 24, arranged in a line corresponding to the selected first transparent electrodes 22a, is sent to all of the second transparent electrodes 22b. Each cell 24, which is located at the intersection point of the selected first transparent electrode 22a and the second transparent electrode 22b, emits colored light according to the received voltage data. A similar operation is carried out for all the all first transparent electrodes 22a, selected one by one.

The time at which the red, green, and blue light are emitted are separated. For example, first, the red light source is ordered to emit a fixed magnitude of red light. While red light is emitted, all voltage data corresponding to the red light is sent to all the unit cells 24 and each cell 24 emits red light, of which the magnitude is controlled. After ordering all the unit cells 24 to emit red light, the red light source is switched off.

Next, the green light source is ordered to emit a fixed magnitude of green light. While green light is emitted, all voltage data corresponding to the green light is sent to all the unit cells 24 and each cell 24 emits green light, of which the magnitude is controlled. After ordering all the unit cells 24 to emit green light, the green light source is switched off.

Next, the blue light source is ordered to emit a fixed magnitude of blue light. While blue light is emitted, all voltage data corresponding to the blue light is sent to all the unit cells 24 and each cell 24 emits blue light, of which the magnitude is controlled. After ordering all the unit cells 24 to emit blue light, the blue light source is switched off.

After ordering the blue light source to emit, the supply of red, green, and blue light to the display unit 20 is repeated, one by one. A full-color image can be displayed on the display unit 20 by repeating the above operation.

According to the above embodiment, a full-color required image can be displayed on the transparent display 10 so a user can observe the optical image of an object by ordering the optical image to pass through the transparent display 10.

In the above embodiment, the light source unit 11 is mounted on a side of the first glass substrate 21a and the light which is emitted by the light source unit 11 is incident on the side of the first glass substrate 21a. However, the light source unit 11 may be mounted on a side of the second glass substrate 21b and the light can be incident on the side of the second glass substrate 21b.

Alternatively, the light source unit 11 may be mounted on a side of the polymer dispersed liquid crystal layer 23 and the light may be incident on the side of the polymer dispersed liquid crystal layer 23. If the light source unit 11 is mounted on a side of the polymer dispersed liquid crystal layer 23, it is preferable to decide the direction in which the light source unit 11 emits red, green, and blue light so that the light incident on the first and second glass substrates 21a, 21b from the polymer dispersed liquid crystal layer 23 is reflected totally on their outside surfaces. Or, the direction in which the light source unit 11 emits light can be decided so that the incident light on the polymer dispersed liquid crystal layer 23 cannot enter the first and second glass substrates 21a, 21b, for example, the incident light progresses along a straight line which is parallel to the interfaces between the polymer dispersed liquid crystal layer 23 and the first and second transparent electrodes 22a, 22b. Even if the incident light is emitted by the light source unit 11 in the above direction, light is scattered at a unit cell 24 when voltage is not applied, and the unit cell 24 can emit the scattered light from the second glass substrate 21b.

In the above embodiment, the edge surfaces of the first glass substrate 21a are perpendicular to the inside and outside surfaces of the first glass substrate 21a. However, the angle between the side surfaces and the inside/outside surfaces can be an angle different from 90 degrees. By adjusting the angle, the angle of incidence of the light progressing inside the first glass substrate 21a, on the inside and outside surfaces can be adjusted.

In the above embodiment, by separately deciding the directions in which the red, green, and blue light source emits red, green, and blue light, the angle of incidence of the light hitting the inside and outside surfaces of the first glass substrate 21a can be adjusted. However, the directions in which the red, green, and blue light source emits red, green, and blue light are fixed in the light source unit 11, and by deciding the direction in which the light source unit 11 faces, the angle of incidence of the light hitting the inside and outside surfaces of the first glass substrate 21a can be adjusted.

In the above embodiment, the light source unit 11 and the first glass substrate 21a are mounted so that the light source unit 11 and the first glass substrate 21a are apart from each other. However, the light source unit 11 and the first glass substrate 21a can be adhered together.

In the above embodiment, fixed magnitudes of red, green, and blue light are emitted from the red, green, and blue light sources. However, the magnitude of the red, green, and blue light can be adjusted for each unit cell 24. If the magnitude of the emitted light is adjusted, it is unnecessary to adjust the voltage applied between the first and second transparent electrodes 22a, 22b. Of course, both the magnitude of the emitted light, and the voltage applied can be adjusted.

In the above embodiment, times when the red, green, and blue light are emitted are separated. However, a plurality of light sources can be ordered to emit light simultaneously. Of course, it is preferable to order the light sources to emit at separate times in order to express various colors. Incidentally, a similar effect can be achieved even if all the light sources are ordered to emit light simultaneously, as long as the magnitude of each light emitted by the light sources is adjusted.

In the above embodiment, the direction in which the light sources emit light is decided so that the incident light in the first glass substrate 21a is reflected totally on the outside surface of the first glass substrate 21a. However, it is not necessary to reflect totally the light on the outside surface of the first glass substrate 21a. If the transparent display 10 is mounted on the viewfinder of a camera as the above embodiment, the transparent display 10 is seen only directly from the front. Consequently, without total reflection, light which is not required to emit from a unit cell 24 and which passes through the outside surface of the second glass substrate 21b rarely reaches a user. Of course, it is preferable that the incident light is reflected on the outside surfaces of the first and second glass substrates 21a, 21b to prevent the luminance of the unit cells 24 from dropping.

In the above embodiment, an organo-electroluminescence device is used as a light source in the light source unit 11. However, the same effect can be achieved even if other kinds of light source, such as an LED, are used. Especially, if the voltage to be applied between the first and second transparent electrodes 22a, 22b is controlled, any kind of light source are adaptable for use. However, if the magnitudes of the emitted light are controlled, a light source where the magnitude of the light can be altered quickly, such as an organo-electroluminescence device, is preferable. In addition, a light source which can supply light uniformly to the entire incident surface of the first glass substrate 21a, such as an organo-electroluminescence device which is a surface-emitting device, is preferable.

In the above embodiment, the voltage data sent to each unit cell 24 is controlled according to the passive matrix method. However, the active matrix method is also adaptable for use.

In the above embodiment, a plurality of unit cells 24 are arranged according to the dot matrix system. However, the unit cells 24 may be arranged according to the segment system by forming the first and second transparent electrodes into a predetermined shape.

In the above embodiment, the first transparent electrodes 22a are arranged so that the first transparent electrodes 22a are parallel lengthwise to the shorter side of the first glass substrate 21a and the second transparent electrodes 22b are arranged so that the second transparent electrodes 22b are perpendicular to the first transparent electrode 22a. However, any arrangement of the first and second transparent electrodes 22a, 22b is acceptable as long as the polymer dispersed liquid crystal layer 23 is mounted between the first and second transparent electrodes 22a, 22b.

In the above embodiment, a reflection material is mounted on the first glass substrate 21a. However, the same effect can be achieved even if a reflection material is not mounted. It is preferable to mount the reflection material to fully utilize the light emitted from the light source unit 11.

In the above embodiment, the light source units 11 are mounted on two sides of the first glass substrate 21a, which is shaped as a rectangular. However, the light source unit 11 can be mounted on one, three, or all sides of the first glass substrate 21a.

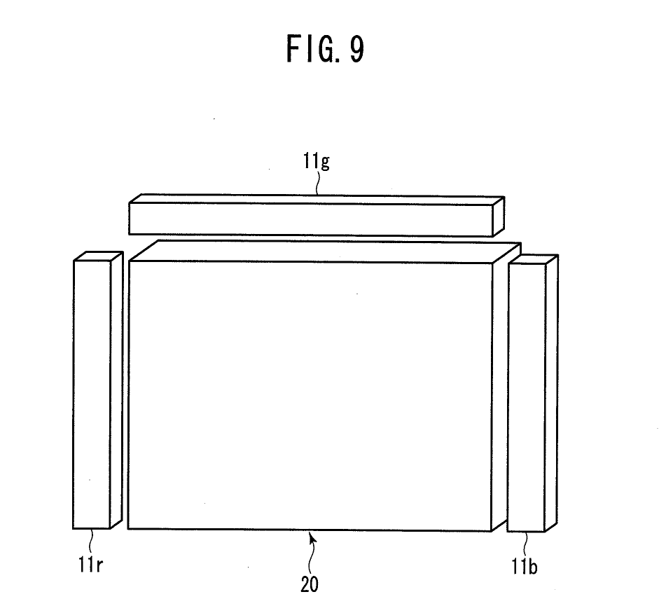

In the above embodiment, one light source unit 11 comprises red, green, and blue light sources. However, a single light source unit 11 may comprise one kind of light source. For example, the same effect can be achieved by mounting a red light source unit 11r, which comprises only a red light source, a green light source 11g, which comprises only a green light source, and a blue light source 11b, which comprises only a blue light source, separately on one side of the first glass substrate 21a, as shown in FIG. 9. Or, one light source unit 11 may comprise two kinds of light source. If the number of kinds of light source which one light source unit 11 comprises is few, the light source unit 11 can be easily manufactured and the manufacturing cost will be lowered.

In the above embodiment, light sources which emit three primary colors are used. However, light sources which emit any other color light are also acceptable.

In the above embodiment, the first and second glass substrates 21a and 21b are used. However, any kind of substrate that is a transparent plate is acceptable.

In the above embodiment, the transparent display 10 is mounted in the single lens reflex camera 30. However, the transparent display 10 may be mounted in any kind of camera. Furthermore, the transparent display 10 may be used for any apparatus, such as binoculars.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2006-148021 (filed on May 29, 2006), which is expressly incorporated herein, by reference, in its entirety.

1. A transparent display, comprising:
first and second transparent substrates that face each other;
first and second transparent electrodes that are mounted on the inside surfaces of said first and second transparent substrates, said inside surfaces of said first and second transparent substrates facing each other;
a polymer dispersed liquid crystal layer that fills the gap between said first and second transparent electrodes and that comprises a polymer material and a liquid crystal, said liquid crystal being dispersed in said polymer material; and
first and second light sources that emit first and second light, of which the colors are first and second colors, in predetermined directions, respectively; said first and second lights being made incident on an edge surface of at least either said first or second transparent substrate; and
said predetermined directions being decided so that said first and second light emitted from said first and second light sources, respectively, and made incident on said edge surface, is reflected at an outside surface which is the opposite of said inside surface.

2. A transparent display according to claim 1, wherein said first and second light sources are arranged on different sides of said first or second transparent substrates.

3. A transparent display according to claim 1, wherein said first and second light sources are arranged on the same side of said first or second transparent substrates.

4. A transparent display according to claim 3, wherein a reflection material that reflects light is mounted on the opposite side of said first or second transparent substrates to where said first and second light sources are arranged.

5. A transparent display according to claim 1, wherein said predetermined direction is decided so that the reflection of said first and second light at said outside surface is total reflection.

6. A transparent display according to claim 1, further comprising a first controller that controls a driving voltage applied between said first and second transparent electrodes.

7. A transparent display according to claim 6, wherein said first controller controls said driving voltage separately when said first controller orders said first light source to emit and said second light source to switch off and when said first controller orders said first light to switch off and said second light source to emit.

8. A transparent display according to claim 1, further comprising a second controller that controls the magnitudes of said first and second light emitted from said first and second light sources, respectively.

9. A transparent display according to claim 1, wherein said liquid crystal is p-type liquid crystal and the refractive index of said p-type liquid crystal against an ordinary ray is substantially the same as that of said polymer material.

10. A transparent display according to claim 1, wherein said liquid crystal is n-type liquid crystal and the refractive index of said n-type liquid crystal against an extraordinary ray is substantially the same as that of said polymer material.

11. A transparent display according to claim 1, wherein a plurality of said first transparent electrodes are mounted so that said first transparent electrodes are arranged lengthwise in a first direction and a plurality of said second transparent electrodes are mounted so that said second transparent electrodes are arranged lengthwise in a second direction different from said first direction.

12. A transparent display according to claim 11, wherein said first direction is perpendicular to said second direction.

13. A transparent display according to claim 1, wherein said first and second light sources are organo-electroluminescence devices.

14. A transparent display: comprising
first and second transparent substrates that face each other;
first and second transparent electrodes that are mounted on the inside surfaces of said first and second transparent substrates, said inside surfaces of said first and second transparent substrates facing each other;
a polymer dispersed liquid crystal layer that fills the gap between said first and second transparent electrodes and that comprises a polymer material and a liquid crystal, said liquid crystal being dispersed in said polymer material; and
first and second light sources that emit first and second light of which the colors are first and second colors in predetermined directions, respectively; said first and second light being made incident on an edge surface of said polymer dispersed liquid crystal; and
said predetermined directions being decided so that said first and second light emitted from said first and second light sources, respectively, and made incident on said inside surface from the side of said polymer dispersed liquid crystal are reflected at an outside surface which is the opposite of said inside surface, or so that said first and second light emitted from said first and second light sources, respectively, and progressing in said polymer dispersed liquid crystal, is parallel to said inside surface.

15. A camera, whose viewfinder optical system comprising:
first and second transparent substrates that face each other;
first and second transparent electrodes that are mounted on the inside surfaces of said first and second transparent substrates; said inside surfaces of said first and second transparent substrates facing each other;
a polymer dispersed liquid crystal layer that fills the gap between said first and second transparent electrodes and that comprises a polymer material and a liquid crystal, said liquid crystal being dispersed in said polymer material;
first and second light sources that emit first and second light, of which the colors are first and second colors, in predetermined directions, respectively; said first and second lights being made incident on an edge surface of at least either said first or second transparent substrate; and
said predetermined directions being decided so that said first and second light emitted from said first and second light sources, respectively, and made incident on said edge surface, is reflected at an outside surface which is the opposite of said inside surface.

16. A camera, whose viewfinder optical system comprising:
first and second transparent substrates that face each other;
first and second transparent electrodes that are mounted on the inside surfaces of said first and second transparent substrates, said inside surfaces of said first and second transparent substrates facing each other;
a polymer dispersed liquid crystal layer that fills the gap between said first and second transparent electrodes and that comprises a polymer material and a liquid crystal, said liquid crystal being dispersed in said polymer material;
first and second light sources that emit first and second light, of which the colors are first and second colors, in predetermined directions, respectively; said first and second light being made incident on an edge surface of said polymer dispersed liquid crystal; and
said predetermined directions being decided so that said first and second light, emitted from said first and second light sources, respectively, and made incident on said inside surface from the side of said polymer dispersed liquid crystal, are reflected at an outside surface which is the opposite of said inside surface, or so that said first and second light emitted from said first and second light sources, respectively, and progressing in said polymer dispersed liquid crystal, is parallel to said inside surface.
